(19) United States
(12) Patent Application Publication
(10) Pub. No.: US 2016/0297230 A1
(43) Pub. Date: Oct. 13, 2016

(54) Method and appartus for combining, storing and retailing multiple storage devices or recording mediums concealed within a greeting card and alike to create a traditional greeting card with literature and art with modern storage devices or recording mediums such as but not limited to compact disc, USB drive's, monetary devices to furnish a way to send but not limited to audio, video's, photo's, literature and information etc's with a greeting card.

(71) Applicant: Raymond Aniban, JR., Ewa Beach, HI (US)

(72) Inventor: Raymond Aniban, JR., Ewa Beach, HI (US)

(21) Appl. No.: 14/545,225

(22) Filed: Apr. 8, 2015

(51) Int. Cl. B42D 15/02; B42D 15/04

(52) U.S. Cl. CPC B42D 15/027; B42D 15/042; B42D 15/045

(57) ABSTRACT

A greeting card, and envelope designed and or formatted to reconfigure to accept and conceal a receptacle by dimension, which stores at least one recording or recorded storage device, medium, or media such as but not limited to DVD's, CD's, Compact disc, USB’ drive's, gift card's, paper currency, etc. The storage devices or mediums allows the giver to download, record, combine and store image's graphic, photo's video's, music, art poetry, literature, records, etc, from an authorized website's and can combined with personal reserves all in a greeting card and create a personal customized album. The images, audio and information can be downloaded on the receivers PC and selected images, audio and the information can be duplicated and printed such as photos can be framed, used as wallpaper etc, and the original storage devices or medium can be stored with the greeting card and receptacle can be stored as albums.

### CROSS-REFERENCE TO RELATED APPLICATION

This application is a Continuation of U.S. Provisional Application 61/995,493 filed Apr. 10, 2014 and should be entitled to the benefit of Provisional application. A NOTICE OF ABANDONMENT UNDER 37 CFR 1.53 (f) OR (g) was mailed Jan. 6, 2015. The reply was mailed Jan. 30, 2015 Express Mail # EK 681359631 US. A Cashier's check for $850.00 (check #2011767 Bank of Hawaii) a return receipt post card stamped Jan. 30, 2015.

MULTIMEDIA DISC AND GIFT CARD

| | |
|---|---|
| Davila, Milton-U.S. Pat. No. 6,666,378 B2 | 12-2003 |

MULTIMEDIA DISC

| | |
|---|---|
| Swenson, Steven C.-U.S. 2006/0032764 A1 | 02-2006 |

HOUSING FOR MULTIMEDIA CARRIER AND/OR DATA CARRIER

| | |
|---|---|
| Fournilier, Jean-Noel-U.S. 2010/0326852 A1 | 12-2016 |

EXPANDABLE COMPACT DISC SHIPPING CONTAINER

| | |
|---|---|
| Cooksey, Edward-U.S. Pat. No. 6,328,160 B1 | 12-2001 |

EXPANDABLE COMPACT DISC SHIPPING CONTAINER

| | |
|---|---|
| Mayer, David-U.S. 2013/0036635 A1 | 02-2013 |

POSTCARD

| | |
|---|---|
| Hart, Preston-U.S. Pat. No. 3,405,467 | 10-1968 |

### FIELD OF INVENTION

This invention relates to both greeting cards and storage devices or recording mediums storage packs.

### BACKGROUND OF THE INVENTION

I realize that sending photos, videos, text, poetry, art, literature, etc, electronically, only a limited amount can be sent at a time. So, I thought that rather than sending an email or text to someone on an occasion, why not send a greeting card with an abundance of photo's, video's, poetry, art, literature, etc, in a media all within a greeting card. Relationships are important, it maybe Mother's Day, Father's Day, Anniversary's, Birthday's, or just to say to a loved one your special and here is what I would like to send you. As they say, a picture say's a thousand words. Then this invention can send a million with a traditional touch by sending a greeting card along with photos, videos, poetry, etc.

Traditional greeting cards are limited to what the envelope of the card could hold, unless the sender supplies and additional mailing package which again limits what can be sent by the size of package selected and additional postage fee's. By diverting from the original envelope also takes away the style and attraction.
(a) Compact disc storage cases are limited to one type of storage device and aren't sent with a greeting card, gift card, photos etc.
(b) When sending a greeting card for a special occasion, in the past picture's would be develop and sent with the greeting card and with the technology of today, such as cellphone's emails and digital camera's media are sent electronically. Meaning multiple medias would be sent and received at different times.

### SUMMARY OF THE INVENTION

The invention is to allow a sender to safely and privately send photos, videos, music, literature, monetary gift cards etc through storage devices along with a greeting card without letting personal items open for hacker's to access.

The sender selects a desired greeting card, if the sender desires to send photos, videos, literature using storage devices, the greeting card and envelope is designed to adapt to the receptacle. The storage devices are loaded with desired contents and the selected adhesive compartment covers are removed and the media is then inserted in its designated compartments of the storage device case and the storage device case is attached to the greeting card inserted into the designed envelope and mailed. Everything is sent and received at the same time, this method keeps the more traditional and personal way of sending photo's, video's, literature, etc, on a special occasion.

### OBJECTS AND ADVANTAGES

The objective and advantage of using this invention is to allow a sender of a greeting card to send a quality and quantity of photo's, videos, audio, literature, poetry, etc, within a greeting card and a stylish mailing package. With the technology of today's media is sent electronically with minimal privacy, security, limited amount of media at a time, as described in the above patent, several objectives and advantages of the invention are:
(a) the sender will be able to design their own CD, DVD, poetry, graphic's, photo albums, etc from an authorized website.
(b) This allows the receiver to view the contents listen to audio content and print the content the receiver desirer's such as photos.
(c) This allows the receiver access to an abundances of recorded content within the storage devices which is received in a package as small as a greeting card.
(d) The greeting card can then be stored as photo albums and labeled with a date and the occasion of receiving the card.
(e) This invention provide a method and apparatus that allows a sender of the greeting card to send an abundance of desired photo's, videos, music, art and literature etc, allowing the receiver to receive these items all at once with a traditional touch.

### BRIEF DESCRIPTION OF THE SEVERAL VIEWS OF THE DRAWINGS

Note: some shading was eliminated to reduce confusion in the drawings.

FIG. 1 shows the invention with the receptacle fastened within an open greeting card between the literature sheet and the back of receptacle with an adhesive removable cover coving a medium compartment.

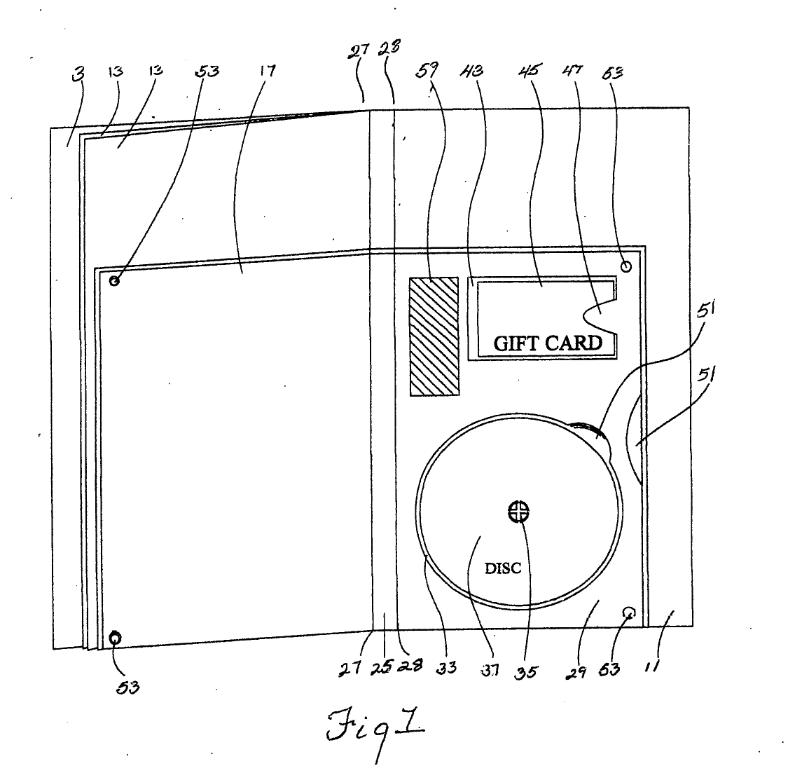

FIG. 2 shows the greeting card with three creases along the length spine of the greeting card.

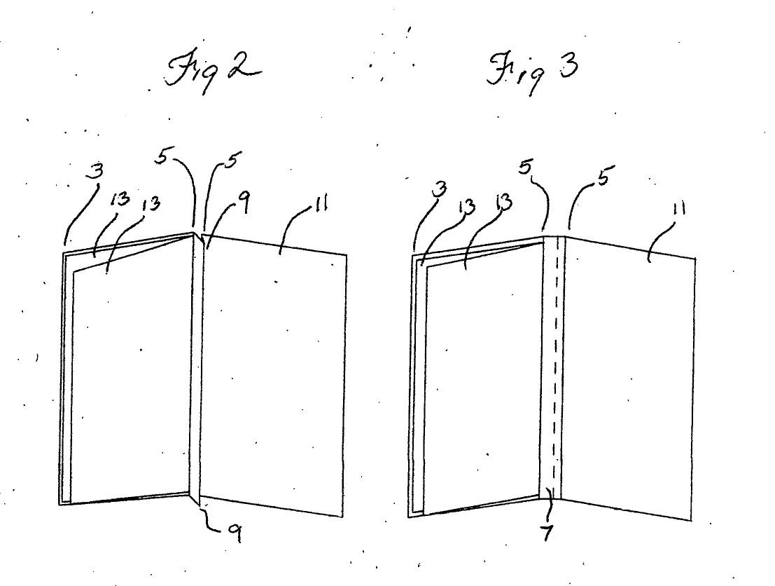

FIG. 3 shows the greeting card adapted for accepting the storage case.

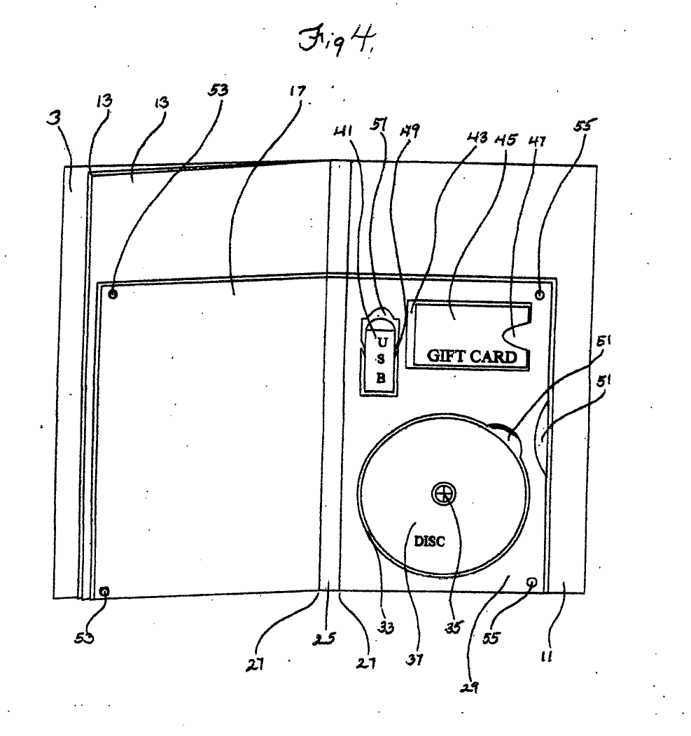

FIG. 4 shows the invention with the receptacle fastened within an open greeting card between the literature sheet and the back of receptacle with an adhesive removable cover coving removed of the medium compartment.

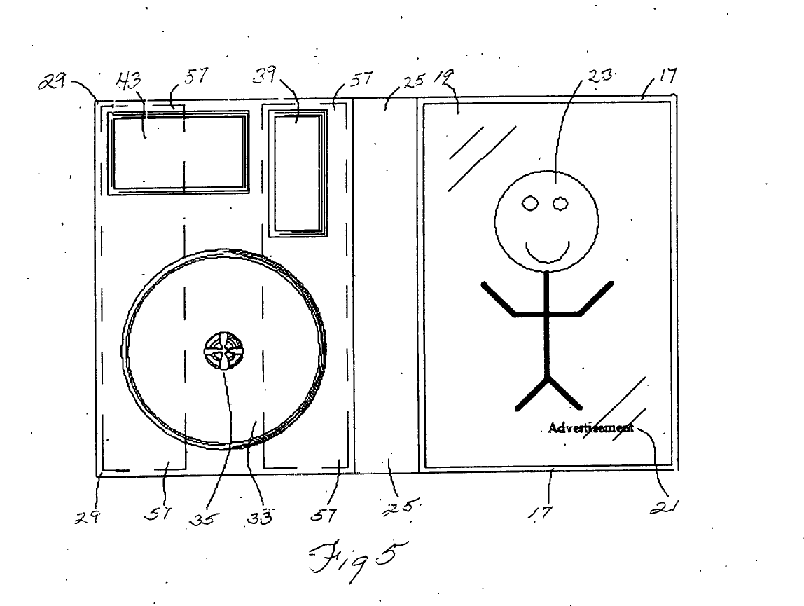

FIG. 5 shows the front cover, spine and back of receptacle with fastening strips along the back of receptacle.

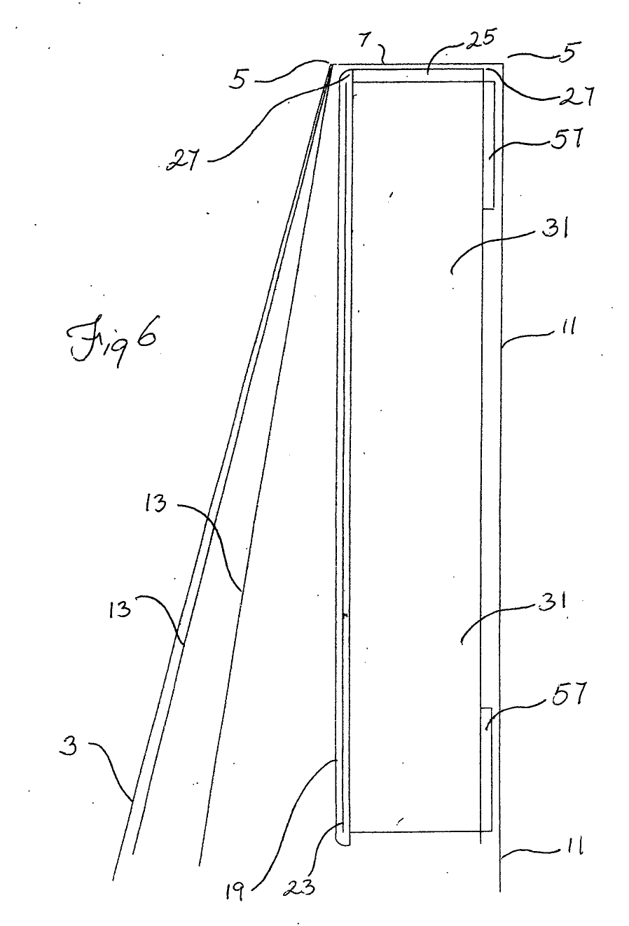

FIG. 6 shows a top view of the receptacle fasten within the greeting card.

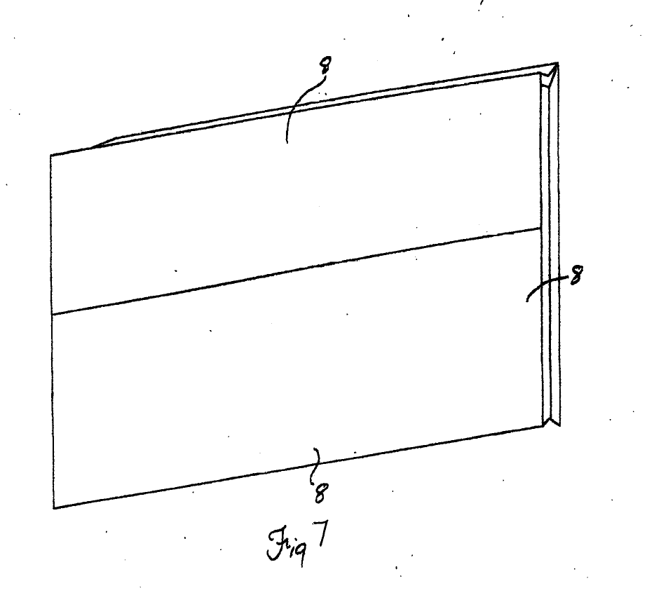

Fig. shows a view of the accordion design envelope partly expanded to accept the greeting card with the receptacle.

FIG. 8 shows a top view of the fasten within the greeting card. shows the accordion design envelope with the greeting card and receptacle within the accordion design envelope.

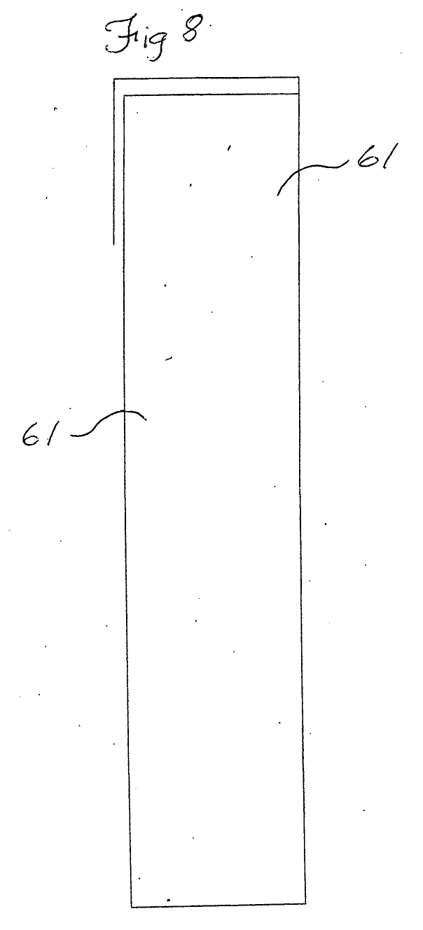

Reference Numeral in Drawings

```
  1. greeting card
  3. front cover of greeting card
  5. living hinge of greeting card
  7. spine of greeting card
  9. crease on spine of the greeting card
11. back cover of greeting card
13. literature sheet
15. receptacle
17. front cover of receptacle
19. clear lament
21. advertisement
23. insert
25. spinc of reccptade
27. living hinge of receptacle
28. standby hinge
29. back of receptaclc
33. compact disc compartment
35. Disc release button
35. Disc release button
37. compact disc
39. storage device or USB compartment
41. storage device or USB
43. monetary value device compartment
45. monetary value device
47. monetary value device brace
49. storage device supports
51. finger recess
53. tab
57. adhesive
59. adhesive compartment covers
61. accordion design envelope
```

### DETAILED DESCRIPTION OF INVENTION

A greeting card 1, with hinges of greeting card 5, which allows a receptacle 15, to fit within the dimension of the front cover of greeting card 3, back cover of greeting card 11, and spine of greeting card 7, and attached or adhered, to the greeting card 1, as illustrated in FIG. (1, 4, 6,).

The greeting card 1, has a crease on spine of the greeting card 9, between two hinge's of greeting card 5, along the spine of greeting card 7, as shown in FIG. (2, 3,), unlike the traditional greeting card, where the traditional greeting card usually has only one living hinge of the greeting card.

The crease on the spine of the greeting card 9, may not necessarily be centered evenly between the living hinges of greeting card 5, of the spine of greeting card 7, as shown in FIG. (2, 3,). By having the crease on spine of the greeting card 9, offset along the spine of greeting card 7, allows just one crease on spine of greeting card 7, visible when facing the front cover of greeting card 3, of greeting card L.

The greeting card 1, may also has multiple literature sheets 13, preferably between or within the front cover of greeting card 3, and front cover of storage case 17, as shown in FIG. (1, 2, 3, 4, 6,)

The greeting card 1, with a receptacle 15, which stores at least one storage device and alike, which may have prerecorded or recorded photos, images, literature, videos, music, records, etc as shown in FIG. (1, 4,).

The receptacle 15, may be constructed by the same method other compact disc storage pack or the multiple storage device case is constructed such as but not limited to injection molding and in a vast arrange of colors which may be made of a recyclable material.

The receptacle 15, consist of a front cover 17, spine of receptacle 25, living hinges 27, of receptacle 15, of receptacle 29, storage case body 31, finger recess 51, male tab 53, female slot 55, compact disc compartment 33, storage device or USB compartment 39, monetary value device compartment 43, clear lament 19, advertisement 21, fastening means, adhesive strip, two way tape, as illustrated in FIG. (1, 4, 5,).

The front cover of storage case 17, and back of receptacle 29, of the receptacle 15, is connected to the spine of receptacle 25, by living hinges of receptacle 27.

The clear lament 19, which is fastened to three sections of receptacle 15, preferably, but not limited to the front cover of storage case 17. The clear lament 19, is fastened on three sides leaving at least one side open as shown in FIG. (5,). This allows an insert 23, such as but not limited to a title of occasion, photo, poem, etc, thru the side of the clear lament 19, which is not fastened to the front cover of storage case. 17, the clear lament 19, also has an advertisement 21, on one side of the clear lament 19, which allows the company or publisher of the greeting card 1, and the receptacle 15, advertise their product to the sender and receiver, to view the brand name or trademark as shown in FIG. (5,).

The storage case body 31, consist of the compact disc compartment 33, which holds at least one compact disc, CD, DVD, etc. as shown in FIG. (1, 4, 5,). The disc release button 35, is the same embodiment but has two functions, this may be designed in many different ways as many different compact disc packs or cases have a variety of designs for a compact disc release or apparatus. as shown in FIG. (1, 4, 5,) after the recording is complete. The disc release button 35, releases the disc when pressed in a downward direction and using the finger recess 51, to insert a finger and lifting the edge of the compact disc 37, in an upward direction.

The storage device or USB compartment 39, consist of the storage device supports 49, which secures the storage device or USB 41, when the storage device or USB 41, is stored in the receptacle 15, as shown in FIG. (4,) and the finger recess 51, which allows the storage device or USB 41, to be removed with a finger.

The monetary value device compartment 43, also consist of a monetary value device brace 47, as shown in FIG. (1, 4,). Once the storage devices are complete with recording the compartment covers 59, made of an adhesive strip of material are removed and the medias are inserted in their designated compartments the receptacle 15, is closed by pressing male tab 53, of front cover of storage case 17, into female slot 55, of the storage case body 31. The compartment covers 59, made of an adhesive strip of material, tape, etc, which may covers unused compartments when a storage device is not used. The tape may cover the compartment at the time of purchase, then removed or vice versa.

The accordion design envelope 61, as shown in FIG. (7,) may come in a vast range of colors preferably but not limited to a color that matches the greeting card 1, or occasion to which the greeting represents for example: red for Valentine Day.

The accordion design envelope 61, is designed for multiple reasons, shipping from a manufacture saves on space which saves on shipping, while shipping in a flattened position, lessens the chance of damage, and to expand to the dimensions to accommodate the receptacle 15, and greeting card 1, as shown in FIG. (8,).

### Description of the Operation

The sender or giver purchase's the greeting card 1, selects the greeting card 1, that is designed, constructed and or formatted as shown in FIG. (2, 3,). If the sender decides to send photos, videos, music, literature, monetary gift cards, etc, using the receptacle 15, the greeting card 1, is then reconfigured as shown in FIG. (3). The greeting card 1, is first designed to be sent without the receptacle 15, as shown in FIG. (2, 3,) so that the company of the greeting card 1, can construct one design for their greeting cards and if receptacle 15, is desired to be sent with the greeting card 1, then the greeting card 1, is then reconfigured to accept the receptacle 15, as shown in FIG. (1, 2, 3, 4, 6,).

The sender fills out the greeting card 1, then loads the storage devices with desired information such as but not limited to photos, audio, video, data etc. The company of greeting card 1, may have a designated website were the sender or giver may login for a fee or a free download of graphics, art, literature, poetry, video's, etc, or anything the company provides to be downloaded from their website, and the sender can combine and design their own literature, photo's, video's etc with downloads of graphics, art, literature, poetry, videos, etc, from the website and send a customized greeting.

Once the storage devices have been loaded, if the storage compartments are covered with the compartment covers 59, the selected compartment covers 59, is removed and the storage device is then inserted into their designated storage compartments, while using the storage device supports 49, which secures the storage devices in their designated compartments as shown in FIG. (1, 4,). The compartment covers 59, may by placed over the unused compartments if any, so that it doesn't seem that a storage device is missing.

The receptacle 15, is closed and secured by tab 55, as shown in FIG. (6,).

The insert 23, may be a photo, poetry, etc is also inserted between the clear lament 19, and front cover of receptacle 17, as shown in FIG. (5,). The greeting card 1, is then formatted to accept the receptacle 15, shown in FIG. (1, 3, 4, 6,)

The greeting card 1, is then opened flat with the face and back of the greeting card 1, facing downward and the inner side of the greeting card 1, is facing upward and with a finger the center crease is pressed out.

The receptacle 15, is then attached to the greeting card 1, the receptacle 15, is fastened by fastening means two way tape 57, as shown in FIG. (1, 4, 6,)

With the receptacle 15, closed the receptacle 15, is then laid flat with front cover of storage case 17, laying face down on the inner side of the front cover of greeting card 3, and the back of receptacle 29, facing upward. The spine of receptacle 25, the of receptacle 15, and spine of greeting card 7, are aligned with each other and having the bottom of the receptacle 15, is flushed with the bottom of the greeting card 1, which allows the weight of the receptacle 15, support the greeting card 1, when placed in a standing position as shown in FIG. (1, 4, 6,).

Once the greeting card 1, and the receptacle 15, are properly positioned the non adhesive strip of the two way tape 57, is removed and the back cover of greeting card 11, is pressed on to the back of receptacle 29, as shown in FIG. (1, 4, 6,).

Both the greeting card 1, receptacle 15, with loaded storage devices are placed into the accordion design envelope 61, as shown in FIG. (8,).

The receiver opens the greeting card 1, and connects the storage devices, and views its contents the sender may have sent, literature, art, photos, videos, music etc, which the receiver may want to print, this allows the sender to send a quantity of contents and allows the receiver to print just the desired contents of their choice. The storage devices are then reinserted into their designated compartments, receptacle 15, is closed and the greeting card 1, can be placed on a self in the a standing position which can be part of a photo, video, audio, etc album. A title and date may be written on the spine of greeting card 7, to identify each individual, occasion, card, or album.

While I have shown and described in considerable detail what I consider to be the preferred form of my invention, it will be understood by those skilled in the art that various changes may be made in the shape and arrangement of the several parts of the device, and that such details are not to limit the scope of my claims.

1-15. (canceled)

16. A method and apparatus for giving photos, videos, poetry, etc via mediums with in a greeting card with a receptacle which is attached to a greeting card with an assortment of selective medium compartments which can store and secure storage medium's or media which may record images, photo's video's, art, etc, text from an authorized website and may store a monetary value device the said greeting card comprising:
a) The said greeting card with a living hinge that can be reconfigured to have two living hinge's when reconfigured while the edge of the front and back of receptacle evenly matched in dimension with or without the said receptacle which opens and closes may art, text, image or barcode that is designed to conceal a receptacle.
b) The said receptacle that opens and closes with an assortment of compartments which can store storage mediums or media.

17. A method and apparatus for giving photos, videos, poetry, etc via mediums with in a greeting card with a receptacle which is attached to a greeting card with an assortment of selective medium compartments which can store and secure storage medium's or media which may record images, photo's video's, art, etc, text from an authorized website and may store a monetary value device the said greeting card of claim 1 wherein has a spine between the said front and or back of receptacle of said greeting card.

18. A method and apparatus for giving photos, videos, poetry, etc via mediums with in a greeting card with a receptacle which is attached to a greeting card with an assortment of selective medium compartments which can store and secure storage medium's or media which may record images, photo's video's, art, etc, text from an authorized website and may store a monetary value device the said greeting card the said spine of claim 3 wherein has a living hinge between the front cover of said greeting card and said spine of the greeting card and a second standby hinge between the back of receptacle of said greeting card and spine of greeting card.

19. A method and apparatus for giving photos, videos, poetry, etc via mediums with in a greeting card with a receptacle which is attached to a greeting card with an assortment of selective medium compartments which can store and secure storage medium's or media which may record images, photo's video's, art, etc, text from an authorized website and may store a monetary value device the said greeting card the said spine of claim 3 has a crease between the two hinge's depending on the method of sale the crease may be eliminated if the said greeting card and the said receptacle are sold or purchased together, however if the greeting card and said receptacle are purchased separately the said crease may be offset from the center of the said spine which allows the living hinge connected to the said front cover of the said greeting card hide the standby hinge connected to the back of receptacle of said greeting card from view when facing the front of said greeting card till the standby hinge is required to accept the said receptacle the crease and the standby hinge are secured together till the standby hinge is needed to accept the said receptacle.

20. A method and apparatus for giving photos, videos, poetry, etc via mediums with in a greeting card with a receptacle which is attached to a greeting card with an assortment of selective medium compartments which can store and secure storage medium's or media which may record images, photo's video's, art, etc, text from an authorized website and may store a monetary value device the said greeting card of claim 1 wherein may have a literature sheet or at least one attached to the said greeting card with art, text.

21. A method and apparatus for giving photos, videos, poetry, etc via mediums with in a greeting card with a receptacle which is attached to a greeting card with an assortment of selective medium compartments which can store and secure storage medium's or media which may record images, photo's video's, art, etc, text from an authorized website and may store a monetary value device the said greeting card the said receptacle of claim 1 wherein consist of a front cover, spine, body of receptacle, and back of receptacle.

22. A method and apparatus for giving photos, videos, poetry, etc via mediums with in a greeting card with a receptacle which is attached to a greeting card with an assortment of selective medium compartments which can store and secure storage medium's or media which may record images, photo's video's, art, etc, text from an authorized website and may store a monetary value device the said greeting card the said receptacle of claim 1 wherein has the said front cover which has a clear lament connected to the said front cover for the displaying of an insert, the said clear lament may have a text and or image on the outer surface of said clear lament for the advertising of a brand and or trademark is connected at three sides of the lament to the said receptacles front cover.

23. A method and apparatus for giving photos, videos, poetry, etc via mediums with in a greeting card with a receptacle which is attached to a greeting card with an assortment of selective medium compartments which can store and secure storage medium's or media which may record images, photo's video's, art, etc, text from an authorized website and may store a monetary value device the said greeting card the said front cover of claim 8 wherein has a means that temporally fastens the said front cover from the receptacle body in a closed position and releases the said front cover and said receptacle body in an opened position and be opened and closed.

24. A method and apparatus for giving photos, videos, poetry, etc via mediums with in a greeting card with a receptacle which is attached to a greeting card with an assortment of selective medium compartments which can store and secure storage medium's or media which may record images, photo's video's, art, etc, text from an authorized website and may store a monetary value device the said greeting card the said spine of claim 7 wherein has at least one living hinge between the said front cover and the said spine of said receptacle for the movement of opening and closing.

25. A method and apparatus for giving photos, videos, poetry, etc via mediums with in a greeting card with a receptacle which is attached to a greeting card with an assortment of selective medium compartments which can store and secure storage medium's or media which may record images, photo's video's, art, etc, text from an authorized website and may store a monetary value device the said greeting card the said spine of claim 7 wherein has a second living hinge connected to the said body of receptacle.

26. A method and apparatus for giving photos, videos, poetry, etc via mediums with in a greeting card with a receptacle which is attached to a greeting card with an assortment of selective medium compartments which can store and secure storage medium's or media which may record images, photo's video's, art, etc, text from an authorized website and may store a monetary value device the said greeting card the said receptacle of claim 7 wherein has an assortment of selective compartments at medium storage compartment which may be covered with an adhesive removable cover until the said compartment is filled, the said medium storage compartment has a supporting and releasing means for the storage of a storage medium.

27. A method and apparatus for giving photos, videos, poetry, etc via mediums with in a greeting card with a receptacle which is attached to a greeting card with an assortment of selective medium compartments which can store and secure storage medium's or media which may record images, photo's video's, art, etc, text from an authorized website and may store a monetary value device the said greeting card the said body of receptacle of claim 7 wherein has at least one recess per medium compartment for the removal of the said storage medium.

28. A method and apparatus for giving photos, videos, poetry, etc via mediums with in a greeting card with a receptacle which is attached to a greeting card with an assortment of selective medium compartments which can store and secure storage medium's or media which may record images, photo's video's, art, etc, text from an authorized website and may store a monetary value device the said greeting card the said back of receptacle body of claim 7 wherein has at least one section on the outer surface of the said back of receptacle with a means that fastens the said receptacle to the said greeting card.

29. A method and apparatus for giving photos, videos, poetry, etc via mediums with in a greeting card with a receptacle which is attached to a greeting card with an assortment of selective medium compartments which can store and secure storage medium's or media which may record images, photo's video's, art, etc, text from an authorized website and may store a monetary value device the said greeting card with the said receptacle, and a means of sealing an accordion designed envelope.
